(19) United States
(12) Patent Application Publication
(10) Pub. No.: US 2009/0255892 A1
(43) Pub. Date: Oct. 15, 2009

(54) METHOD AND APPARATUS TO REMOVE AND REPLACE FACTORY INTERFACE TRACK

(75) Inventors: Kieran Noel Collins, Placitas, NM (US); Adrian L. Borden, Albuquerque, NM (US)

Correspondence Address: PATTERSON & SHERIDAN, LLP - - APPM/TX, 3040 POST OAK BOULEVARD, SUITE 1500, HOUSTON, TX, 77056, US

(73) Assignee: Applied Materials, Inc., Santa Clara, CA (US)

(21) Appl. No.: 12/399,474

(22) Filed: Mar. 6, 2009

Related U.S. Application Data
(60) Provisional application No. 61/034,450, filed on Mar. 6, 2008.

(51) Int. Cl. B66C 19/00; B23P 6/00

(52) U.S. Cl. 212/319; 29/402.08

(57) ABSTRACT

A method and apparatus for removing and replacing an existing component with an upgraded component disposed in an enclosure is described. The method includes removing a first portion of the component and mounting a tool capable of movement in four degrees of freedom on a surface of the enclosure. The tool is attached to a second portion of the component and the second portion of the component is removed from the enclosure. A replacement component, having a first and second portion, is installed inside the enclosure. Embodiments further provide a lifting apparatus having at least one support brace detachably coupled to opposing sides of an enclosure attached to a processing tool. The upper support beam is slidably coupled with the support brace and a lower support beam is rotatably and slidably coupled with the upper support beam.

### CROSS-REFERENCE TO RELATED APPLICATIONS

This application claims benefit of U.S. provisional patent application Ser. No. 61/034,450, filed Mar. 6, 2008, which is herein incorporated by reference.

### BACKGROUND OF THE DISCLOSURE

1. Field of the Invention

Embodiments of the invention relate to servicing and/or upgrading components or components within a system with minimal downtime. More specifically, to replacing a component or components within a semiconductor processing system with another component while incurring minimal downtime.

2. Description of the Background Art

Semiconductor devices, which include integrated circuits, are manufactured in “clean room” environments in order to not contaminate the devices being fabricated. These fabrication facilities are commonly referred to as “fabs”.

The various semiconductor fabs throughout the world generally follow a fairly standard design in the layout of the clean room facility. A manufacturing area of the fab is designated to have the cleanest environment in order not to contaminate the various devices being fabricated on the semiconductor wafers or substrates. The manufacturing area often contains a factory material handling system to decrease contamination of substrates during processing.

A wafer or substrate carrier handler may receive wafer carriers from the factory material handling system at one or more of its load ports in a factory interface (FI). The factory interface generally includes load ports for receiving the carriers, a transfer unit and a frame or “mini-environment.” A closed-type wafer container can separate environments in the clean room by preventing exposure of the wafers in the container to the clean room environment. A front opening unified pod (FOUP) is one type of closed-type wafer container.

Removal and replacement of components within FI systems in a semiconductor fab can result in tool down time and decreased production. FI systems may be attached to an existing wall separating the mini-environment from the rest of the fab. The FI system is typically removed from the wall and transported through the fab to a maintenance area for removal and replacement of components within the FI system. This procedure often results in production bay shut downs and greatly reduced tool downtime. Therefore, there is a need for an apparatus and method for removing components within FI systems that eliminate disruption to the production flow in a fab.

### SUMMARY OF THE INVENTION

The present invention generally provides a method for removing a component disposed in an enclosure attached to a processing tool. The method includes removing a first portion of the component and mounting a tool capable of movement in four or more degrees of freedom on a surface of the enclosure. The tool is attached to a second portion of the component and the second portion of the component is removed from the enclosure. A replacement component, having a first and second portion, is installed inside the enclosure.

Embodiments further provide a lifting apparatus having at least one support brace detachably coupled to opposing sides of an enclosure attached to a processing tool. The upper support beam is slidably coupled with the support brace and a lower support beam is rotatably and slidably coupled with the upper support beam.

Embodiments further provide a factory interface having an enclosure and a robot track assembly disposed within the enclosure. The factory interface also includes a tool capable of movement in four or more degrees of freedom coupled to the enclosure.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

FIG. 1 is plan view of a subsystem coupled to a larger system according to one embodiment of the invention.

FIG. 2 is a plan view of the subsystem and larger system illustrated in FIG. 1 with removed components according to one embodiment of the invention.

FIG. 3 is an isometric view of the subsystem and a component in installed position according to one embodiment of the invention.

FIG. 4 is an isometric view of the lifting apparatus supporting the component inside the subsystem according to one embodiment of the invention.

FIG. 5 is an isometric view of the component moved through a side opening and rotated to a front opening of the subsystem according to one embodiment of the invention.

FIG. 6 is an isometric view of the component rotated and moved through a front opening of the subsystem according to one embodiment of the invention.

FIG. 7 is an isometric view of the component attached to a first wheeled support according to one embodiment of the invention.

FIG. 8 is an isometric view of the component attached to a first and second wheeled support according to one embodiment of the invention.

FIG. 9 is an isometric view of the lifting apparatus according to one embodiment of the invention.

FIG. 10 is an isometric view of the lifting apparatus according to one embodiment of the invention.

FIG. 11 is an isometric view of the subsystem and lifting apparatus showing movement in four or more degrees of freedom according to one embodiment of the invention.

FIG. 12 is an isometric view of the subsystem and lifting apparatus showing movement in four or more degrees of freedom according to one embodiment of the invention.

To facilitate understanding, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION

The invention generally provides a method and apparatus for removing and replacing a component or components of a subsystem within or coupled to a larger system without major disassembly and/or detachment of the subsystem from the larger system. The apparatus and method may use existing mounting points for existing components and is adapted to remove the existing component, and install an upgraded or replacement component, within an enclosure using access openings that are existing on the enclosure. This results in minimal downtime of the subsystem and larger system and minimal disruption of production in the fabrication facility, which results in increased profitability.

The apparatus and method uses a combination of the four or more degrees of freedom to remove the existing component, and install a replacement component, within an enclosure. It should be noted that the four or more degrees of freedom may include movement in the X, Y, and Z directions, rotation in the X-Y plane i.e. rotation about the Z-axis, rotation in the X-Z plane i.e. rotation about the Y-axis, and rotation in the Y-Z plane i.e. rotation about the X-axis. Movement and rotation in any of the directions may be either actuated manually, such as by a worker, or by automatically, such as by machine. The apparatus and method is also configured to operate without the use of large cranes and other lift devices that may not be present in the fabrication facility and may pose problems if introduced into the clean environment of the fabrication facility.

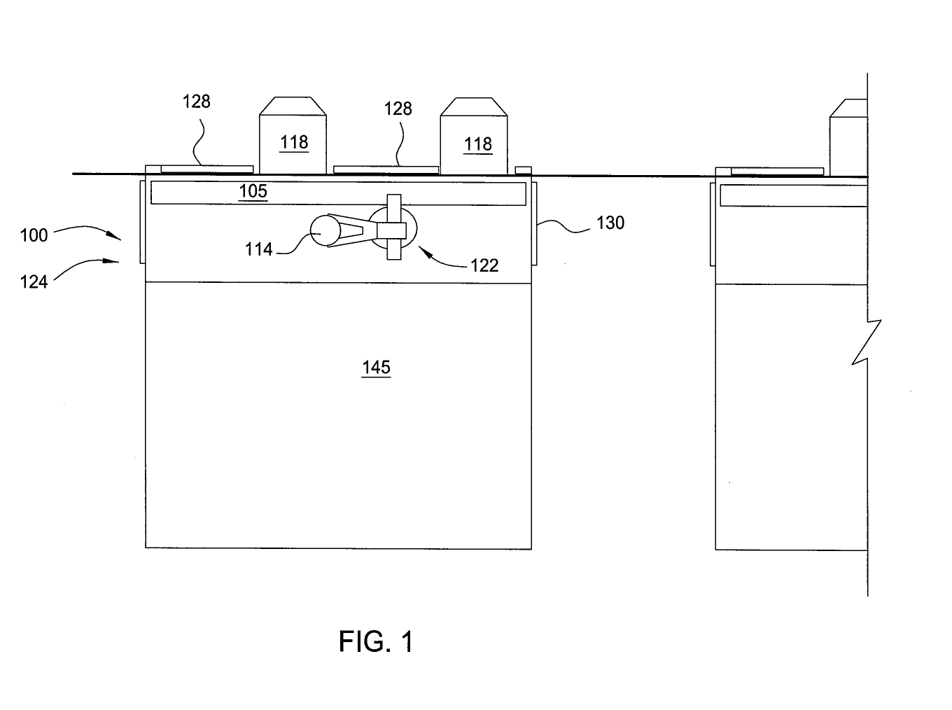

In one example shown in FIG. 1, a subsystem, such as a factory interface (FI) 100 used to store, transfer, and process semiconductor substrates 114, may be coupled to a larger system or tool, such as a chemical mechanical polishing (CMP) platform or processing tool 145 used to polish the semiconductor substrates, is described. The FI 100 includes a plurality of substrate storage cassettes, such as front opening unified pod (FOUP) 118 disposed in loadports. Each loadport may be selectively opened and closed with covers 128. A side port access panel 130 covers a side access door 135.

A user of the CMP platform or processing tool 145 and FI 100 may desire replacement of a transfer robot disposed within the FI. The transfer robot typically includes a first portion comprising a robot assembly 122, such as an end effector, one or more robot arms, and various drive systems, and the first portion is disposed on a second portion, such as a track assembly 105. Typically, the robot assembly 122 may be decoupled from the track assembly 105 and the robot assembly 122 may be removed from the FI enclosure manually, or with the use of hoists and lifting devices within the clean room.

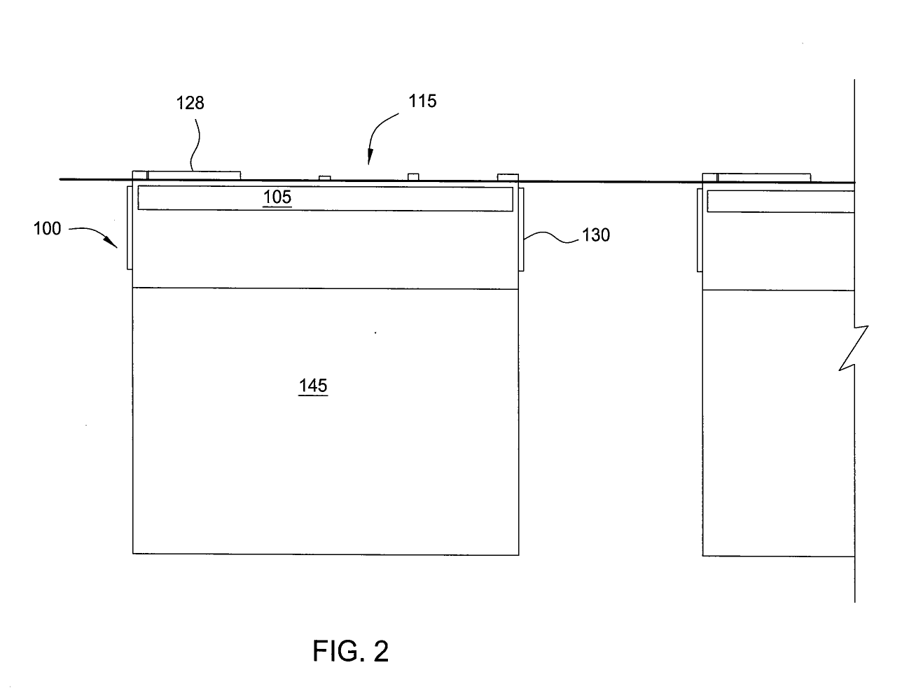

The track assembly 105 is generally bulkier and heavier as compared to the robot assembly 122, and typically requires more substantial lifting force to remove and replace. Conventionally, a user must detach the FI at the interface between the FI and the CMP platform in order to remove the track assembly. This detachment from the CMP platform and other disassembly procedures may cause significant tool downtime and a substantial disruption in production within the fabrication facility. However, the inventors have found that the track assembly will fit through openings 115 in the FI enclosure if the track assembly is aligned at a suitable angle. A crane has been designed to fit within the FI enclosure 124 and manipulate the track assembly 105 out of the enclosure 124 as shown in FIGS. 2-8.

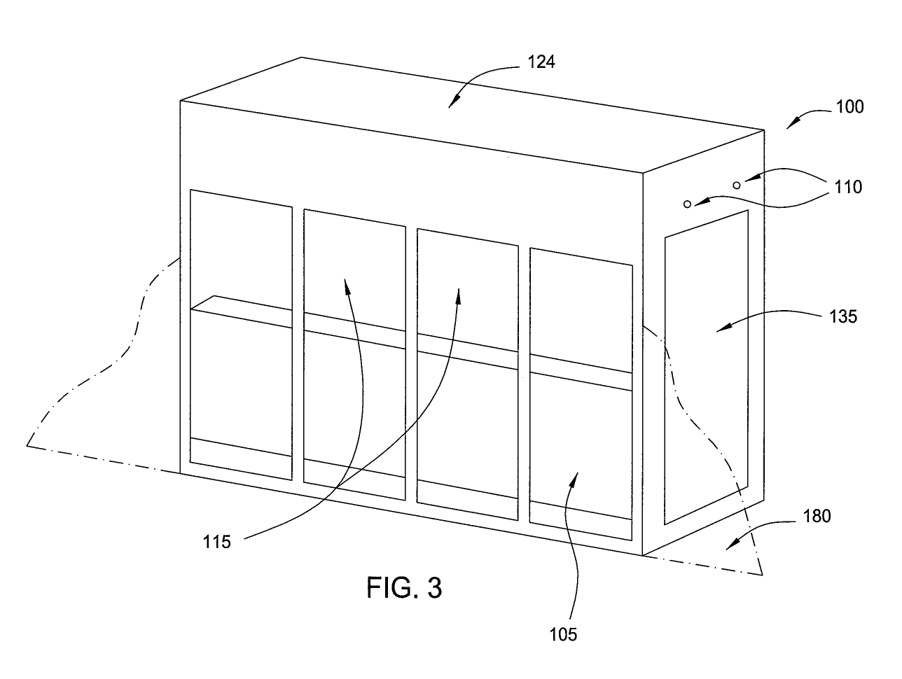

FIG. 2 is a plan view of the subsystem and larger system illustrated in FIG. 1 with removed FOUPS 118 and robot assembly 114. The panels or covers 128 are removed to allowing access into the enclosure 124. FIG. 3 shows an isometric view of the subsystem, such as FI 100, and a component, such as a handler robot track assembly 105 in installed position according to one embodiment of the invention. The FI 100 includes an enclosure 124 having mounting points 110, a side access door 135 and front openings 115, which may include the loadports. A wall 180 may surround portions of the FI 100 and be used to create a “mini-environment” to reduce contaminates in the processing region of a fab.

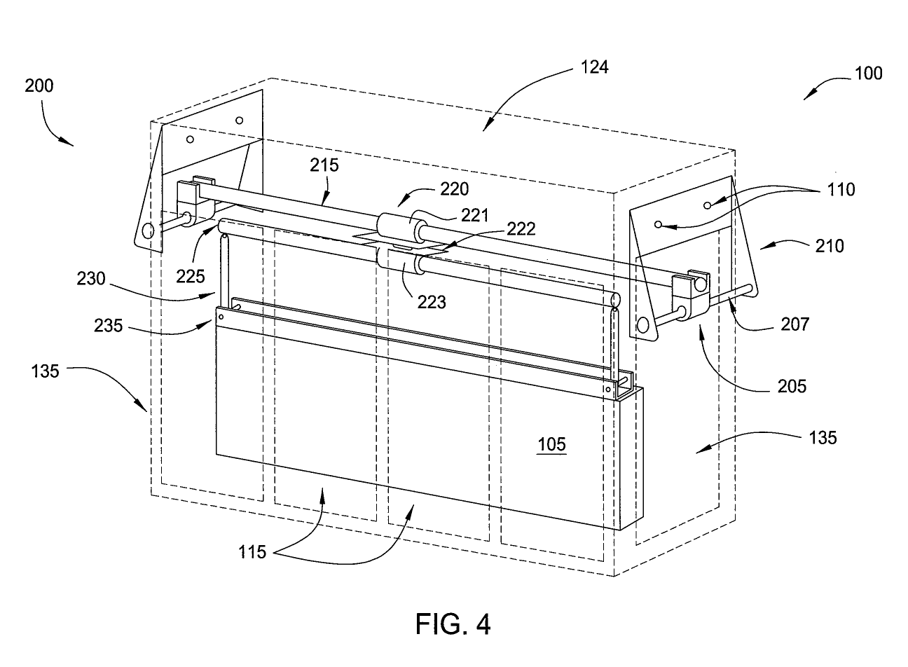

FIG. 4 is an isometric view of the lifting apparatus 200 supporting the component, such as a handler robot track assembly 105, inside the subsystem, such as a FI 100 according to one embodiment of the invention. The lifting apparatus 200 includes at least one support brace 210 detachably coupled to opposing sides of an enclosure 124 attached to a processing tool 145. An upper support beam 215 is slidably coupled with the support brace 210 and a lower support beam 225 is rotatably and slidably coupled with the upper support beam 215. The upper support beam 215 may be slidably coupled with the support braces 210 by linear bearings 205 attached to the upper support beam 215 and a cross-beam 207 that is a part of the support brace 210. The upper support beam 215 may move in one degree of freedom relative to the enclosure. The upper support beam 215 may move relative to the enclosure by rollers or other slide mechanism. The support brace 210 may be mounted to the opposing sides of the enclosure using the existing mounting points 110. Any conventional means of attaching the support brace 210, such as screws, brackets, bolts, etc., may be used to attach the support brace 210 to the enclosure 124. The lifting apparatus 200 may be coupled to existing hardware within the enclosure 124 or on the outside of the enclosure. In one embodiment, the enclosure 124 includes an integral hoist mechanism that is configured to lift and manipulate the robot assembly 122 for maintenance and other purposes.

In one embodiment, the lower support beam 225 includes a Z lift 230 at opposing ends of the support beam 225. The Z lift 230 may be a turnbuckle, though other lifting/lowering devices may be used. It should be noted that the term “Z lift” means any device that may raise or lower a component in a vertical or “Z” direction. Attached to the Z lift 230 may be a device to attach the track assembly 105 to lifting apparatus 200, such as a U-shaped track adapter 235.

In one embodiment, the lifting apparatus 200 includes a coupling device 220 capable of moving in two or more degrees of freedom relative to any of the support braces 210, the upper support beam 215, and the lower support beam 225. The coupling device 220 may include an upper linear bearing 221, a turntable 222, and a lower linear bearing 223. The coupling device 220 enables the lower support beam 225 to rotate in the horizontal or X-Y plane about the Z-axis. The coupling device 220 also allows the lower support beam 225 to rotate at various angles relative to the upper support beam 215, which allows the lower support beam 225 and track assembly 105 to move linearly and angularly when the track assembly 105 is coupled thereto. The lower support beam 225 may move in two or more degrees of freedom relative to the enclosure 124.

In another embodiment, a factory interface 100 includes an enclosure 124, a robot track assembly 105 disposed within the enclosure 124, and a tool, such as a lifting apparatus 200, capable of movement in four or more degrees of freedom coupled to the enclosure 124. The lifting apparatus 200 includes at least one support brace 210, an upper support beam 215 slidably coupled with the support brace 210, and a lower support beam 225 rotatably and slidably coupled with the upper support beam 215. Other embodiments of lifting apparatus 200 may include those already described.

Thus, according to embodiments, while the FI 100 is coupled to the CMP platform or processing tool 145, the existing robot assembly 122 may be removed with the integral hoist mechanism and removed from the enclosure 124. The crane or lifting apparatus 200 may be provided to the enclosure 124 and coupled to the existing hoist mechanism, such as service mounting points 110. The track assembly 105 may be coupled to the crane or lifting apparatus 200 and manipulated up and out of the enclosure 124 through existing openings 115 in the enclosure 124. A replacement track assembly and robot assembly may be installed in the FI 100 through the existing openings in a generally reverse operation. A more detailed discussion of this embodiment of the invention is found below.

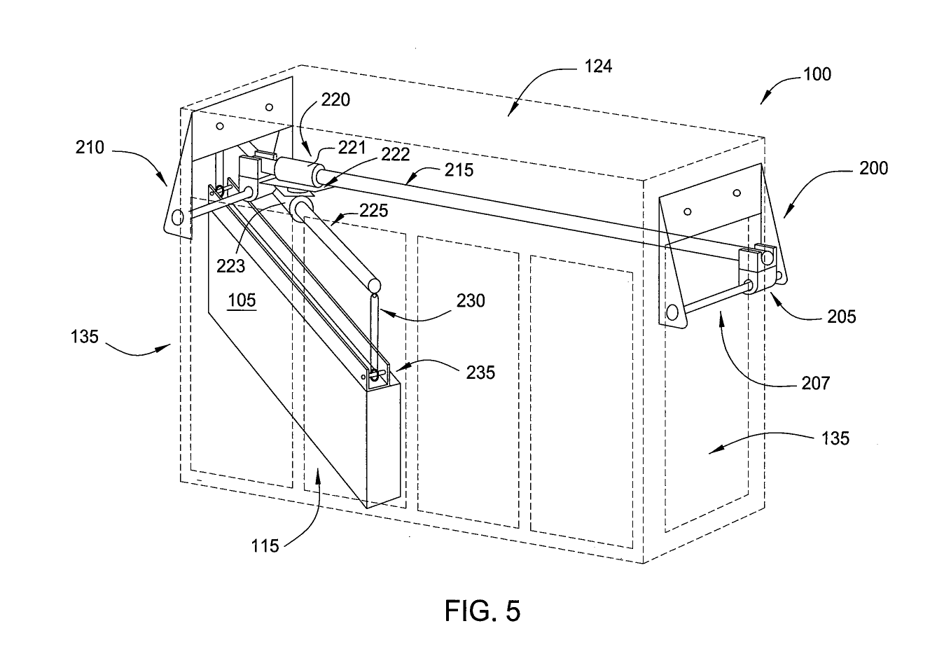

Another embodiment discloses a method for removing a component, such as a robot track assembly 105 disposed in an enclosure 124 attached to a processing tool 145 as shown in FIGS. 1-8. FIG. 5 illustrates an isometric view of the robot track assembly 105 moved through a side opening or access door 135 and rotated to a front opening 115 of the subsystem according to one embodiment of the invention.

As previously shown in FIGS. 1 and 2, a first portion of the component, such as robot assembly 122 is removed from the enclosure 124 of FI 100. A tool, such as lifting apparatus 200, capable of movement in four or more degrees of freedom is mounted on a surface of the enclosure 124. The lifting apparatus 200 is attached to a second portion of the component, such as the track assembly 105. The track assembly 105 is then removed from the enclosure 124. The track assembly 105 may be attached to the lifting apparatus 200 using a U-shaped track adapter 235. The track assembly 105 is hoisted by the Z lifts 230. As shown in FIG. 5, the track assembly 105 is transported to one side of the FI 100 and rotated so that a portion of the track assembly 105 fits through a side access door 135.

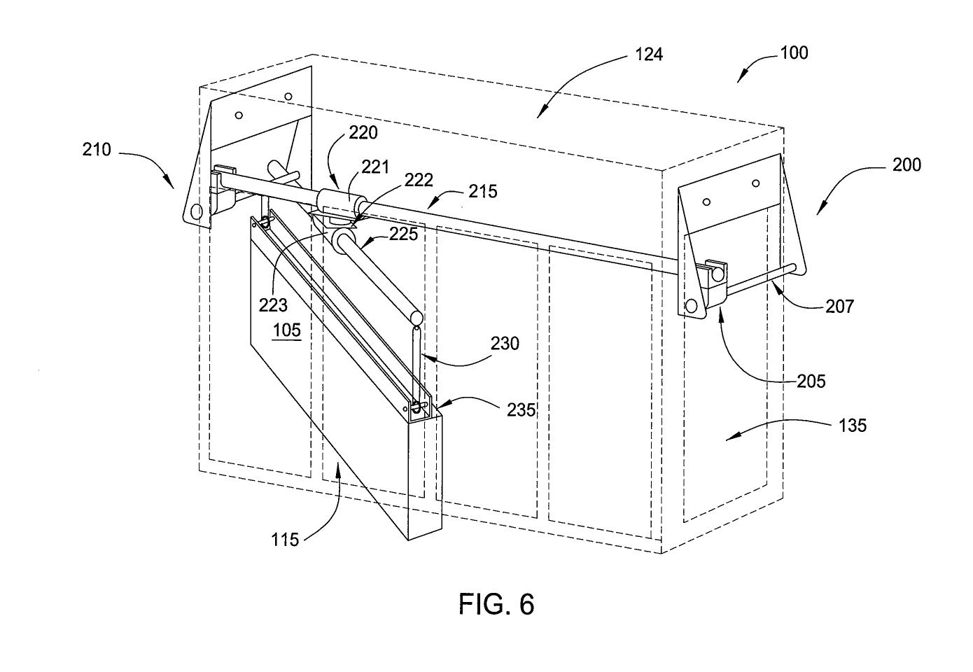

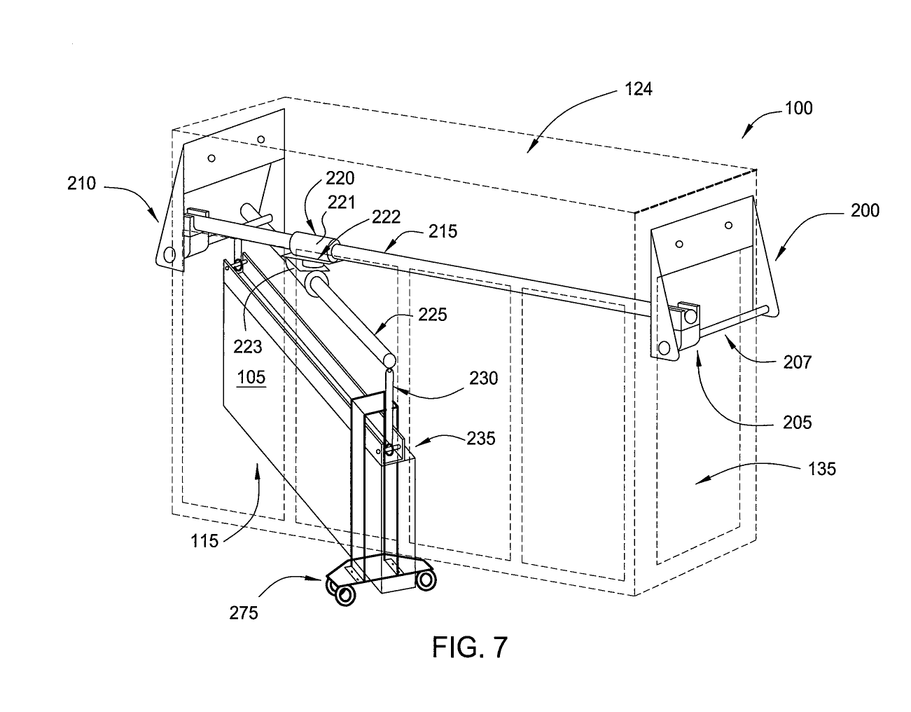

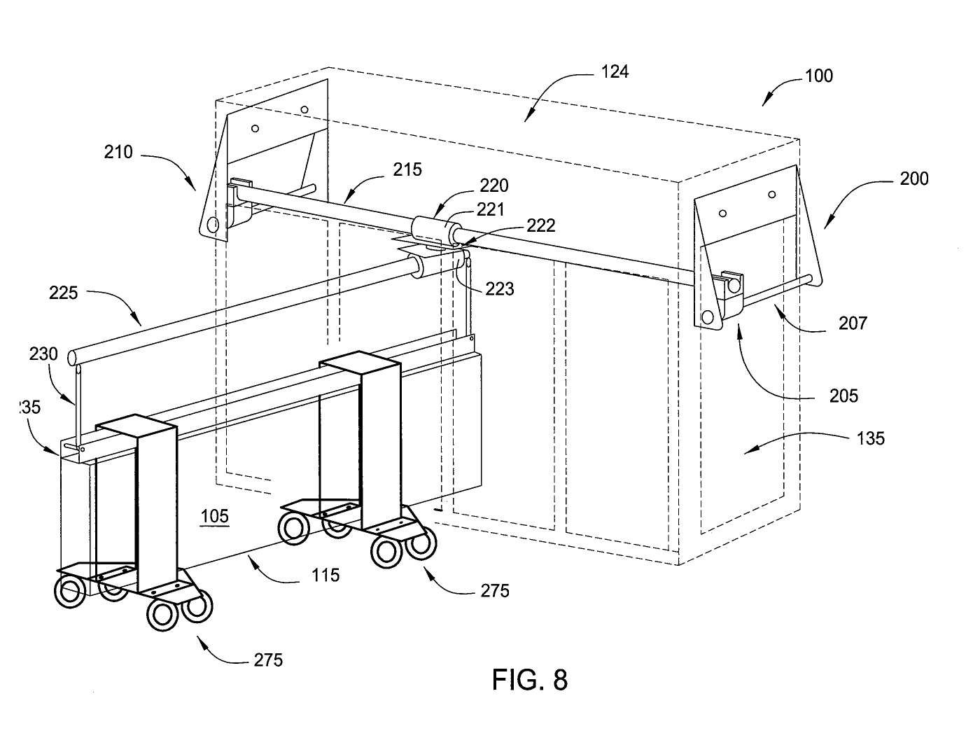

FIG. 6 shows the track assembly 105 rotated to align with an access opening 115 in the front panel of the FI 100. The track assembly 105 is then transported partially out of the enclosure 124 by sliding the lower support beam 225 towards the center of upper support beam 215, while also rotating the lower linear bearing 223 of coupling device 220. FIG. 7 shows the track assembly 105 outside of the front opening 115 of the FI 100. A portion of the track assembly 105 is coupled to a wheeled support 275, such as a dolly or skate. FIG. 8 shows the track assembly 105 transported further outside of the FI 100 and coupled to another wheeled support 275. The track assembly 105 is transported by further rotating the lower linear bearing 223 of the coupling device 220 and sliding the lower support member 225 towards a central portion of the upper support beam 215. The track assembly 105 is thus removed through existing openings in the enclosure 124. The track assembly 105 may then be transported on wheeled supports 275 to another location within the fab, such as a maintenance bay.

A replacement track assembly and robot assembly may be installed inside the enclosure 124. For example, the lifting apparatus 200 may be attached to a replacement robot assembly 122 and installed in the enclosure 124. A replacement track assembly may be wheeled into position in front of the FI 100. The lift apparatus 200 is then attached to the track assembly 105 and installed in the enclosure 124. According to embodiments described herein, the robot assembly 122 and the track assembly 105, including replacements, may be removed and installed through existing openings in the enclosure 124, such as side access door 135 and front openings 115.

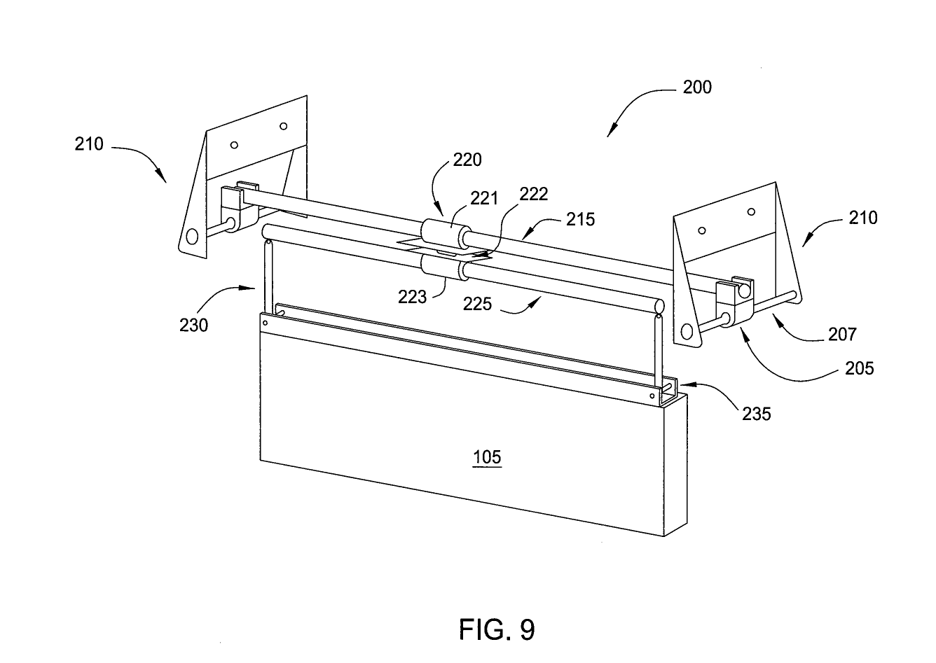

FIG. 9 is an isometric view of the lifting apparatus 200 according to one embodiment of the invention without the FI 100. The lifting apparatus 200 may include support braces 210, an upper support beam 215 slidably coupled with the support braces 210, and a lower support beam 225 rotatably and slidably coupled with the upper support beam 215. The upper support beam 215 may be slidably coupled with the support braces 210 by linear bearings 205 attached to the upper support beam 215 and a cross-beam 207 that is a part of the support brace 210.

In one embodiment, the lower support beam 225 includes a Z lift 230 at opposing ends of the lower support beam 225, such as a turnbuckle. Attached to the Z lift 230 may be a device to attach the track assembly 105 to the lifting apparatus 200, such as a U-shaped track adapter 235. In one embodiment, the lifting apparatus 200 includes a coupling device 220 capable of moving in two or more degrees of freedom relative to any of the support braces 210, the upper support beam 215, and the lower support beam 225. The coupling device 200 may include an upper linear bearing 221, a turntable 222, and a lower linear bearing 223.

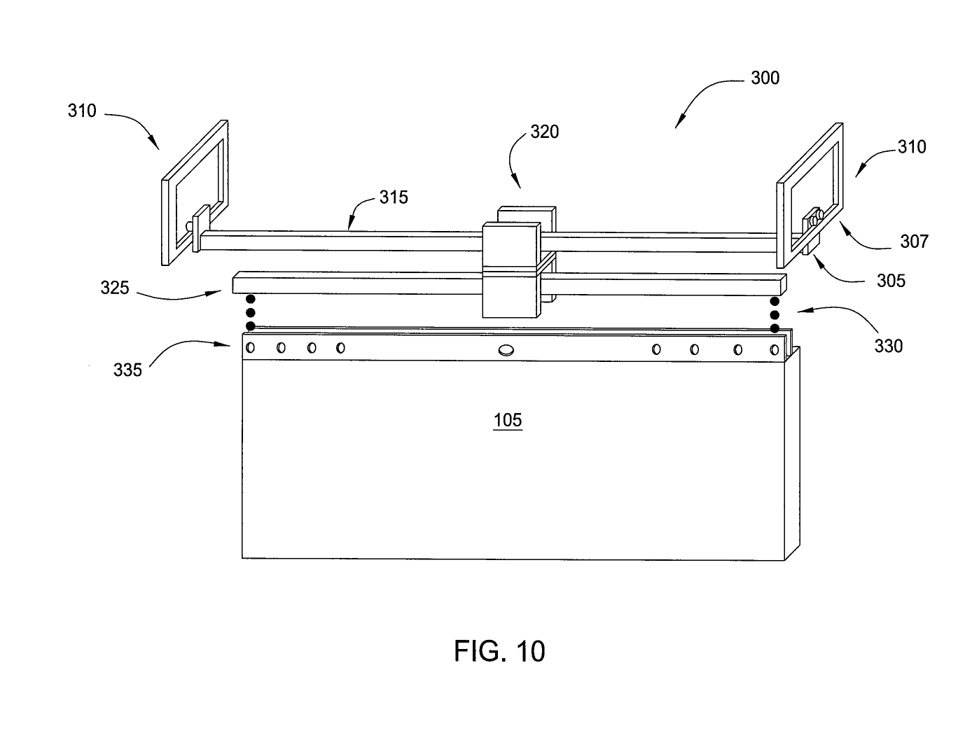

FIG. 10 is an isometric view of the lifting apparatus 300 according to another embodiment of the invention. The lifting apparatus 300 includes square support braces 310, a rectangular shaped upper support beam 315 slidably coupled with the square shaped support brace 310, and a rectangular shaped lower support beam 325 rotatably and slidably coupled with the upper support beam 315. The upper support beam 315 may be slidably coupled with the support braces 310 by wheel based bearings 305 attached to the upper support beam 315 and a bottom cross-beam 307 of support braces 310. Other embodiments of the invention include various cross-sectional shapes for the upper and lower support beams. Various shapes of support braces and coupling devices may also be used other than those disclosed in the Figures.

In one embodiment, the lower support beam 325 includes a Z lift 330 at opposing ends of the lower support beam 325. Attached to the Z lift 330 may be a device to attach the track assembly 105 to the lifting apparatus 300, such as a track adapter 335. In one embodiment, the lifting apparatus 300 includes a coupling device 320 capable of moving in two or more degrees of freedom relative to any of the support braces 310, the upper support beam 315, and the lower support beam 325.

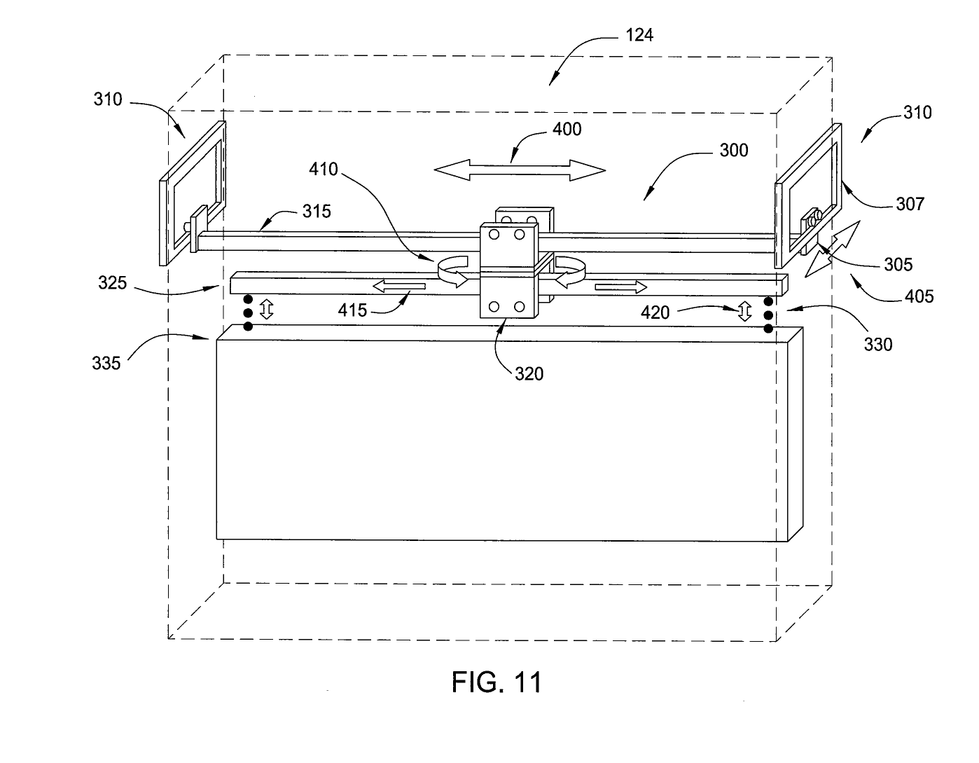

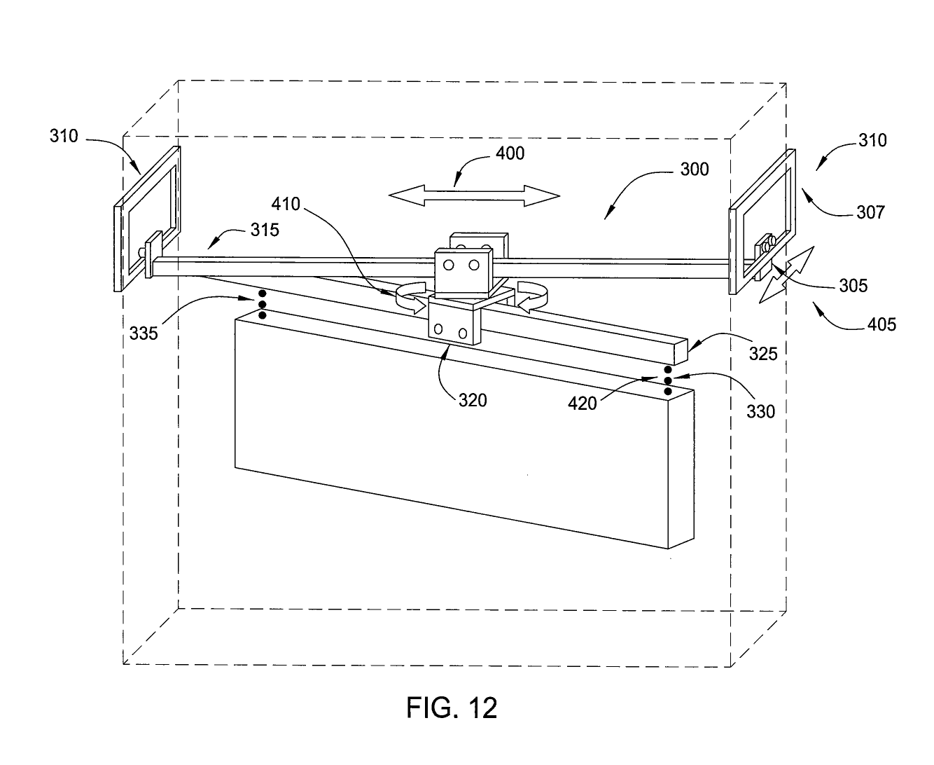

FIGS. 11 and 12 illustrate various movement directions of the crane or lifting apparatus 300. The upper support beam 315 can move in a front and back direction, or a Y direction as indicated by arrow 405 relative to the enclosure 124. The lower support beam 325 may move in a side to side direction, or an X direction as indicated by arrows 415. The lower support beam 325 may also be enabled to move in the X direction by the rotating a lower bearing of the coupling device 320, which slidably moves in the X direction along the upper support beam 315, as indicated by arrow 400.

The rotating coupler device 320 may also rotate 360° about the Z axis in either direction as indicated by arrows 410. The Z lift 330 enables movement of the track assembly 105 in an up and down or Z direction as indicated by arrows 420. Movement in a fifth degree of freedom may include rotating the track assembly 105 in a front to back direction i.e. rotating about the X-axis. The lower linear bearing 323 may rotation around the lower support beam 325, enabling the track assembly 105 to rotated in a front to back direction. Movement in a sixth degree of freedom may include rotating the track about the Y-axis by having the Z-lifts hoist one end of the track assembly 105 higher than the opposite end. The various degrees of freedom of movement enabled by the lifting apparatus allow multiple combinations of movement that enables transfer of the track assembly 105 from inside the enclosure, through an opening in the enclosure, to outside the enclosure, without moving the enclosure or detaching the enclosure from the processing tool or a wall inside a fab.

The advantages of the invention include: no detachment and/or moving of the FI; no wall work needs to be performed, such as removing all or a portion of a wall within the fabrication facility to access the FI and/or relocate the FI; no total shutdown of the fabrication facility bay where the FI is located; and a great reduction in tool downtime.

While the foregoing is directed to embodiments of the invention, other and further embodiments of the invention may be devised without departing from the basic scope thereof, and the scope thereof is determined by the claims that follow.

What is claimed is:

1. A method for removing a component disposed in an enclosure attached to a processing tool, comprising:
removing a first portion of the component;
mounting a tool capable of movement in four or more degrees of freedom on a surface of the enclosure;
attaching the tool to a second portion of the component;
removing the second portion of the component from the enclosure; and,
installing a replacement component inside the enclosure, the replacement component having a first and second portion.

2. The method of claim 1, further comprising:
attaching the tool to the first portion of the replacement component;
installing the first portion of the replacement component in the enclosure;
attaching the tool to the second portion of the replacement component;
installing the second portion of the replacement component in the enclosure.

3. The method of claim 1, wherein the first portion of the component and the first portion of the replacement component is a robot assembly.

4. The method of claim 1, wherein the second portion of the component and the second portion of the replacement component is a track assembly.

5. The method of claim 1, wherein the first portion of the component is removed manually.

6. The method of claim 1, wherein the second portion of the component is removed, and the second portion of the replacement component is installed, through existing openings in the enclosure.

7. The method of claim 1, wherein the first portion of the component is removed, and the first portion of the replacement component is installed, through existing openings in the enclosure.

8. The method of claim 7, wherein the existing opening comprises one of a loadport for a substrate storage cassette and an access door.

9. A lifting apparatus, comprising:
at least one support brace detachably coupled to opposing sides of an enclosure attached to a processing tool;
an upper support beam slidably coupled with the support brace; and,
a lower support beam rotatably and slidably coupled with the upper support beam.

10. The apparatus of claim 9, wherein the lower support beam includes a Z lift at opposing ends thereof.

11. The apparatus of claim 10, wherein each Z lift comprises a turnbuckle.

12. The apparatus of claim 9, further comprising:
a coupling device capable of moving in two or more degrees of freedom relative to any of the support brace, the upper support beam, and the lower support beam.

13. The apparatus of claim 9, wherein the upper support beam includes linear bearings at opposing ends thereof.

14. The apparatus of claim 9 wherein the upper support beam moves in one degree of freedom relative to the enclosure.

15. The apparatus of claim 9, wherein the lower support beam moves in two or more degrees of freedom relative to the enclosure.

16. The apparatus of claim 9, wherein the support brace couples to the enclosure at existing mounting points.

17. A factory interface, comprising:
an enclosure;
a robot track assembly disposed within the enclosure; and
a tool capable of movement in four or more degrees of freedom coupled to the enclosure.

18. The factory interface of claim 17, wherein the tool further comprises:
at least one support brace;
an upper support beam slidably coupled with the support brace; and,
a lower support beam rotatably and slidably coupled with the upper support beam.

19. The factory interface of claim 18, wherein the lower support beam includes a Z lift at opposing ends thereof.

20. The factory interface of claim 19, wherein each Z lift comprises a turnbuckle.

21. The factory interface of claim 18, wherein the tool further comprises:
a coupling device capable of moving in two or more degrees of freedom relative to any of the support brace, the upper support beam, and the lower support beam.

22. The factory interface of claim 18, wherein the upper support beam includes linear bearings at opposing ends thereof.

23. The factory interface of claim 18 wherein the upper support beam moves in one degree of freedom relative to the enclosure.

24. The factory interface of claim 18, wherein the lower support beam moves in two or more degrees of freedom relative to the enclosure.
